(19) United States
(12) Patent Application Publication
(10) Pub. No.: US 2016/0208857 A1
(43) Pub. Date: Jul. 21, 2016

(54) BEARING ISOLATOR

(71) Applicant: A.E.S Engineering Limited, Rotherham (GB)

(72) Inventors: Christopher John Rea, Rotherham (GB); Heath Stephenson, Rotherham (GB)

(73) Assignee: AES Engineering Ltd., Rotherham, OT (GB)

(21) Appl. No.: 14/913,438

(22) PCT Filed: Aug. 20, 2014
(86) PCT No.: PCT/GB2014/000325

§ 371 Date: Feb. 22, 2016

(30) Foreign Application Priority Data
Aug. 20, 2013 (GB) GB1314889.5

(51) Int. Cl. F16C 33/80; F16J 15/447

(52) U.S. Cl. CPC F16C 33/80; F16J 15/447

(57) ABSTRACT

A bearing isolator for controlling fluid flow includes a static component fixed relative to a housing and a rotational component fixed relative to a shaft. The static and rotational components are held axially relative to each other and an annual sealing member is provided. The annual sealing member has a first position in contact with both the static and rotational components and a second position in contact with either, or both, of the static or rotational components. The profile of the static and rotational components is shaped to create a flow path between them with the flow path having at least one feature to slow the flow of fluid therethrough.

### FIELD OF THE INVENTION

This invention relates to bearing protectors and their use in rotating equipment, especially devices, which prevent the ingress or egress of a fluid or solid to a cavity, preventing undue deterioration of equipment life. Such devices are also often referred to as bearing seals or bearing isolators. The use of such rotary seals extends beyond the protection of a bearing in rotating equipment. Accordingly, while reference will be made below to bearing Isolators, it should be understood that this term is used, as far as the invention is concerned, in connection with much wider uses. More broadly, the term isolator device may be used.

### BACKGROUND TO THE INVENTION

An Isolator Device, or Bearing Isolator, is typically used to prevent the ingress of fluid, solids and/or debris into the bearing chamber whilst equally preventing the egress of fluid and/or solids from the bearing chamber. Typically a Bearing Isolator prevents water and dust particles from entering the bearing chamber and grease or oil from leaking out.

There are two commonly used types of bearing protection which are categorised as: Repeller or Labyrinth Bearing Isolators; and Mechanical Seal Bearing Isolators. The invention described in this document follows the former of these two categories and is labyrinthine in design; consisting of a rotating element and a stationary element both of which have inversely similar profiles which fit together forming a complex or torturous path.

It has been observed that when bearing chambers are in use, the temperature within the bearing chamber rises above that of the ambient temperature of the surrounding environment. When this occurs a pressure differential is created between the bearing chamber and the atmosphere such that there is a higher pressure in the bearing chamber. To relieve this pressure a static shut-off device can be employed, extensively detailed in Patent number US20100219585A1.

More simply a single O Ring can be used in contact with both the rotary and stationary elements of the proposed invention such that the O Ring rests on two surfaces thus creating a seal when the bearings are not in use. When the bearings are in use the O Ring dynamically lifts off the contacting surface of the rotary element thus creating a path through which pressure can be released.

Reference is made to Patent number WO2008155530A1 and U.S. Pat. No. 3,044,787 wherein it is substantially described that a sealing O Ring held on a angled surface such that in dynamic operation where a micro gap is formed between two intended surfaces.

It is beneficial that all Bearing Isolators are unitised in their design such that when they are built up they form a single element, thus reducing the chance of tampering, damage or loss of parts. In order to achieve this several methods are employed, including but not limited to the use of a circlip or PTFE ring to create an interlocking part. Methods which use a dedicated component such as a circlip or PTFE ring tend to be more expensive and add complexity to the supply chain. It has also been noted that tolerencing in the PTFE shield can have an effect on the performance of the seal and with circlips it is necessary to have them situated such that they are relatively stationary.

Reference is made to Patent number WO2012075254; wherein is described a labyrinth style bearing protector which incorporates an interlockable stator and rotor.

### STATEMENTS OF INVENTION

The present invention is directed to a device comprising a static component fixed relative to a housing and a rotational component fixed relative to a shaft, the static component and rotational components held axially relative to each other, wherein the means of holding the rotor axially relative to the stator is through a contacting surface such that the minimum axial distances between the stator and the rotor are substantially constant and wherein the contacting annular surface is designed to initially wear to the point that a microgap is formed between the stator and rotor. The use of a contacting surface, which is preferably annual, allows for the components to be aligned using the contact of the components to ensure that they are positioned correctly. The contacting surface, which may be in the form or a sacrificial part or nib, ensures correct alignment of the parts because the annular surface can be positioned using sufficient force to ensure that it is in place, without the risk of it being misaligned or forced too far in. When the device is then operated for the first time, the surface, or nib, is worn away and a gap is created to allow the parts to rotate freely. Such an alignment aid is particularly advantageous where the parts may be arranged with parallel surfaces due to the decreased risk of off-parallel positioning.

The component featuring the sacrificial surface may be formed in a material that is softer than to surface that is to be contacted to ensure that it is worn away upon rotating the respective part. Alternatively, the sacrificial surface may comprise a surface coating applied to the component part so that the components may comprise the same materials with the sacrificial surface being readily removed by wearing upon operation.

More preferably, the contacting annular surface is designed to initially wear to the point that a microgap is formed between the stator and rotor. Where in the wearing surface aids in the first instance to set the internal clearances and in the second instance to better protect against the ingress of fluids and/or solids.

The invention may extend to an isolator device for use in controlling fluid flow, wherein the isolator device comprises a static component fixed relative to the housing and a rotational component fixed relative to a shaft, the static component and rotational component held axially relative to each other, wherein an annular sealing member is provided, the annual sealing member having a first position in contact with both the static component and the rotational component and a second position in contact with either or both of the static component and the rotational component, wherein the profile of the static and rotational components are shaped to create a flow path between them and wherein the flow path comprises at least one feature to slow the flow of fluid therethrough. The use of at least one feature to slow the fluid through the flow path allows for a filtering mechanism to be introduced to reduce the risk of potentially harmful solids and/or fluids ingressing through the system. The flow path may comprise bends, corners, curves, baffles, protrusions, tapering, filters and/or other elements, such as a tortuous shape.

The ability for the annual sealing member to move from a first position to a second position provides a pressure relief system whilst the rotational component is rotating relative to the static component.

According to the present invention there is provided a Bearing Isolator for use in hindering fluid flow between a static component, herein referred to as a housing, a rotational component, herein referred to as a shaft, wherein is included a sealing stationary component, herein referred to as the stator, which is relatively fixed with the housing such that it can be considered a primary sealing component, a rotary component, herein referred to as the rotor, which is relatively fixed with the shaft such that it can be considered to be a secondary sealing component and a tertiary annular sealing member which can be said to be in contact with both the stator and rotor whilst the shaft is stationary and in a secondary state whilst the shaft is in motion such that it is in a non permanent state of contact with either or both the stator and rotor and wherein is included a means for ensuring that the stator and rotor are held axially relative to each other and further where the profiles of said stator and rotor are such that a tortuous path is formed between their respective profiles in such a manner as to aid the repelling and expulsion of fluids and/or solids and furthermore is additionally included in the profiles of the stator and rotor a diameter that is equal to or less than that of an axially contained diameter situated on the opposing component.

Advantageously, the profile of a first component comprises an annular recess and the profile of the other component comprises an annular protrusion and wherein the protrusion of the other component is received within the recess of the first component to form part of the flow path.

Preferably, the protrusion is substantially at one edge of the first component and forms a lip that is received within a corresponding recessed edge of the other component, thereby creating an overhang.

Preferably, the outermost part of the stator is such that it is the same or lesser in diameter to that of the largest diameter of the rotor. More preferably, the diameter of the outermost part of the stator is lesser then the largest diameter of the rotor. Such design aids to improve the labyrinthine profile of the seal in order to reduce the velocity of potentially harmful fluids and/or solids and preventing their ingress. The profile of the outermost part of the static component provides a means of unitisation, between the stator and rotor. The outermost part of the static component may comprise a lip and the rotational component may comprise a corresponding recess.

Preferably, the profile of the outmost part of the stator provides a means of unitisation between the stator and rotor. More preferably, the unitisation is such that the rotor passes through a state of interference with the stator during assembly. Such unitisation allows for cost effective assembly and minimises the potential for loss of parts or tampering.

Preferably, the section of profile of the rotor which forms the largest diameter is such that the diameters of the profile sections immediately adjacent on the stator are lesser in diameter at their lowest point. More preferably, the adjacent surfaces are angled to create a deflecting surface to the normal path of the labyrinth, such that the path of entrance through the labyrinth is significantly deflected further reducing the velocity of harmful fluids and/or solids and providing a self perpetuating barrier.

Preferably, the means of holding the rotor axially relative to the stator is through a contacting annular surface such that all internal clearances are set as designed on installation.

Preferably, the tortuous path is formed through one or more concentrically protruding profiles. More preferably, the protruding profiles are concentrically lesser in diameter such that it can be said that they are interlaced. A profile formed in such a manner creates a more arduous path for ingressed fluids and/or bodies to get through.

Preferably, the tortuous path that is formed by the interfacing sections has included in its profile one or more annular grooves. The annular grooves further aid in the prevention of ingress.

Preferably, there is included in the lowest gravitational point of the stator an internally protruding void such that the ingress of fluid and/or solids may be removed from the internal cavity of the isolator device. More preferably, the internally protruding void allows for the release of ingressed fluids and/or solids from all internal cavities situated prior to the tertiary annual sealing member. The protruding void, or cut out, therefore allows all ingressed fluids and/or solids to be removed before they are able to enter the sealing cavity.

Preferably, the tertiary sealing member, or toroidal O Ring, is situated on the rotor such that whilst the shaft is rotating the O Ring is continually energised into a lifted state. More preferably, the O Ring is under a small amount of stretch such that it is positively sat on the sealing surfaces of the rotor and stator.

### BRIEF DESCRIPTION OF THE DRAWINGS

The accompanying drawings are as follows:

FIG. 1 is a cross sectional view of a first embodiment of a Bearing Isolator in accordance with the present invention;

FIG. 2 is an enlarge view of part of the system of FIG. 1;

FIG. 3 is an embodiment of the unitising feature;

FIG. 4 is a further embodiment of the unitising feature;

FIG. 5 is another embodiment of the unitising feature;

FIG. 6 is a cross sectional view of a second embodiment of a Bearing Isolator in accordance with the present invention;

FIG. 7 is a more detailed view of the embodiment shown in FIG. 6;

FIG. 8 is a further embodiment of an overhung static component in accordance with the present invention;

FIG. 9 is a cross sectional view of another embodiment of a Bearing Isolator in accordance with the present invention;

FIG. 10 is a more detailed view of the embodiment shown in FIG. 9;

FIG. 11 is a different embodiment of a tortuous path in accordance with the present invention;

FIG. 12 is yet another embodiment of a tortuous path in accordance with the present invention;

FIG. 13 is a cross sectional view of another embodiment of a Bearing Isolator in accordance with the present invention;

FIG. 14 is a more detailed view of the embodiment of the sealing toroidal member shown in FIG. 13;

FIG. 15 is an embodiment of the sealing toroidal member in accordance with the present invention;

FIG. 16 is a further embodiment of the sealing toroidal member in accordance with the present invention;

FIG. 17 is yet a further embodiment of the sealing toroidal member in accordance with the present invention;

FIG. 18 is a cross sectional view of the lower section of an embodiment of a Bearing Isolator in accordance with the present invention;

FIG. 19 is a more detailed view of the lower section of FIG. 18 detailing the drainage port; and

FIG. 20 is a view of another embodiment of the present invention.

### DETAILED DESCRIPTION OF THE INVENTION

The invention will now be described, by way of examples only, with reference to the accompanying drawings.

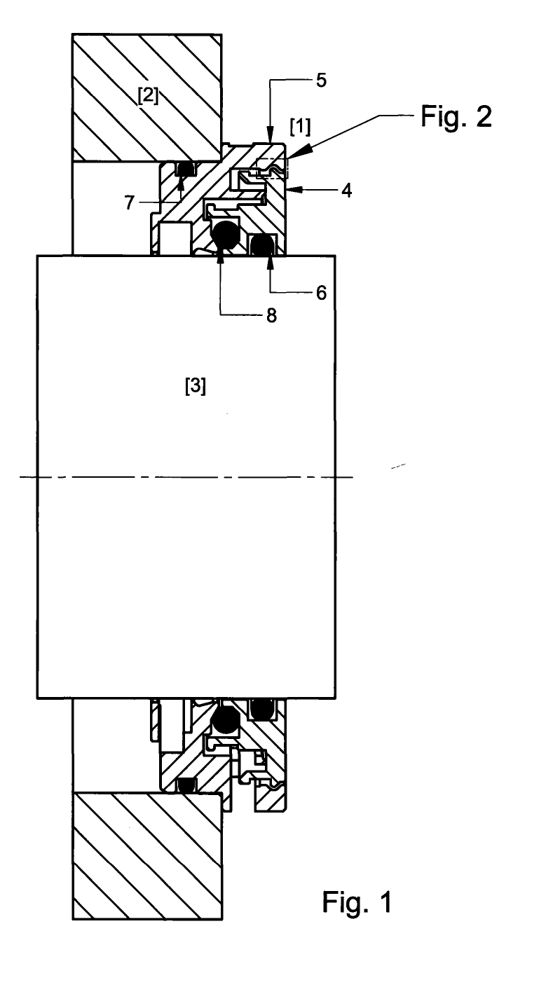

Referring to FIG. 1 of the accompanying drawings, there is shown a cross sectional view of a Bearing Isolator 1 which is fitted into a bore 2 and over a rotating shaft 3 of which the bore 2 and the rotating shaft 3 make up a single piece of rotating equipment. Typically included within the bore 2 but not shown in the accompanying drawings is a bearing. The Bearing Isolator 1 consists of a rotary component 4, a stationary component 5, a rotary sealing O Ring 6, a statically sealing O Ring 7 and a dynamically sealing O Ring 8.

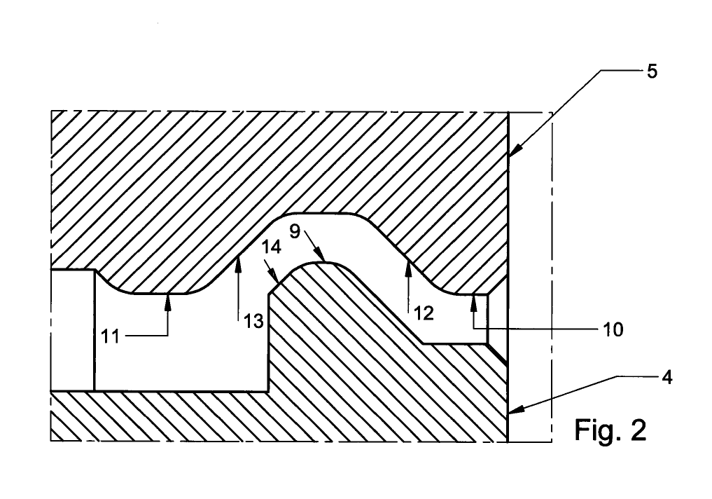

Referring to FIG. 2 of the accompanying drawings, there is shown a close up of the interlocking sections of the rotary component 4 and the stationary component 5 where the largest diameter 9 of the rotary component 4 is greater than the following diameter 10 and the preceding diameter 11 of the stationary component 5 such that a horizontal line may not be drawn between the two components and where the largest diameter 9 is adjacent to two inclined annular surfaces 12 and 13 and thus forms a labyrinthine path between the rotary component 4 and the stationary component 5. Further there is included in the rotary component 4 an inclined surface 14 such that the inclined surface 14 may aid the assembly of the rotary component 4 and the stationary component 5 by concentrically aligning the rotary component 4 and reducing the initial interference between the largest diameter 9 and the following diameter 10.

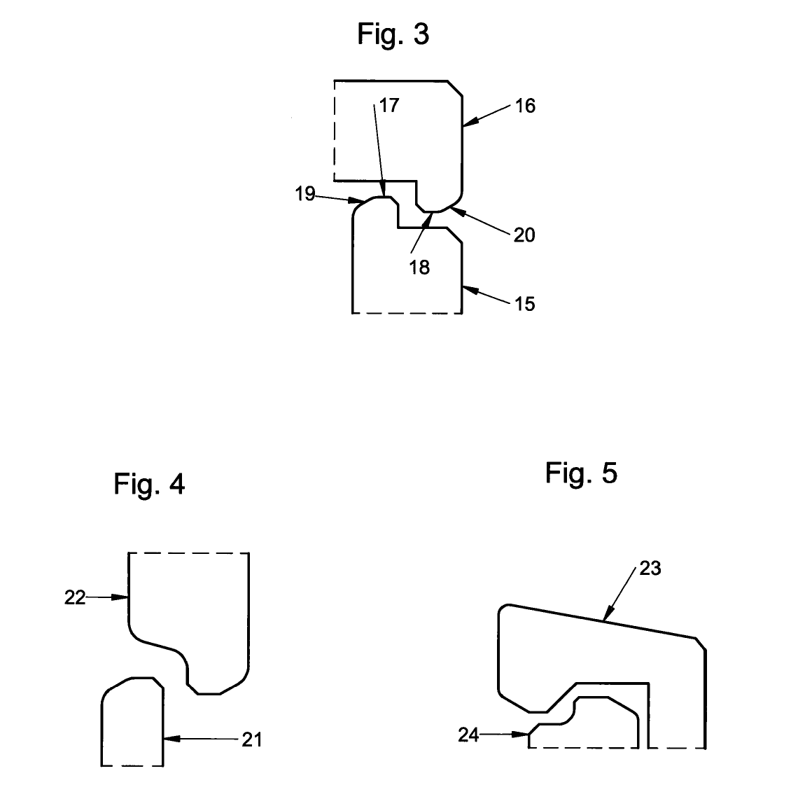

Referring to FIG. 3 of the accompanying drawings, there is shown a close up of an embodiment of the interlocking section wherein is included a rotary component 15 and a stationary component 16 such that the largest diameter 17 of the rotary component 15 is greater than the following diameter 18 on the stationary component 15. There is also provided in this embodiment of the design a leading inclined surface 19 which reduces initial interference with the stationary component 15 and aligns on inclined surface 20.

Referring to FIG. 4 of the accompanying drawings, there is shown a close up of an embodiment of the interlocking section substantially described in FIG. 3 where there is included a rotary component 21 and a stationary component 22 situated such that the stationary component 22 substantially protrudes over the body of the rotary component 21.

Referring to FIG. 5 of the accompanying drawings, there is shown a close up of an embodiment of the interlocking section similarly described in FIG. 3 and where there is included a rotary component 23 and a stationary component 24 whereby the rotary component is disposed such that it encompasses the stationary component 24 thus providing further protection against the ingress of foreign bodies.

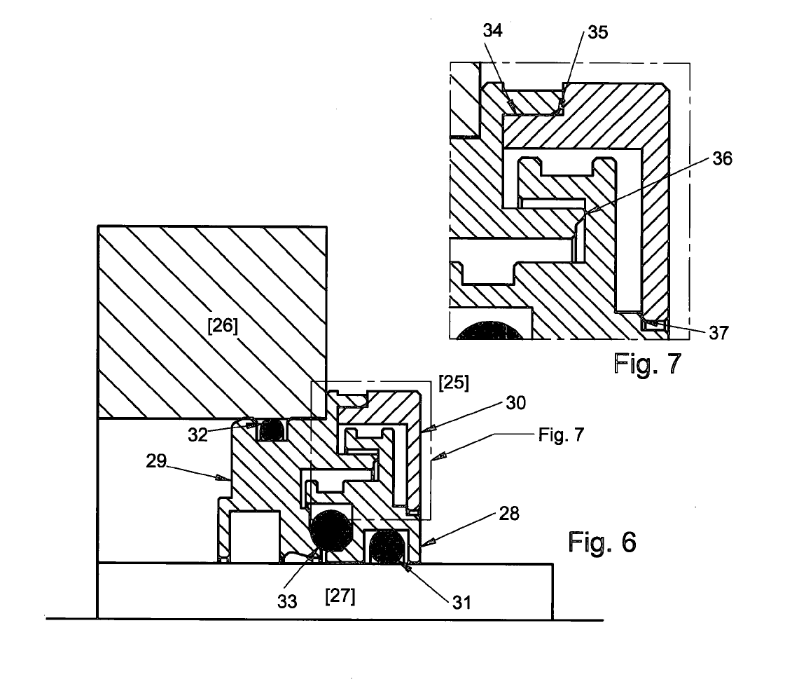

Referring to FIG. 6 of the accompanying drawings, there is shown a cross sectional view of a secondary embodiment of a Bearing Isolator 25 which is shown fitted into a bore 26 and over a rotating shaft 27 includes a rotary component 28, a primary stationary component 29, an overhanging component 30, a rotary sealing O Ring 31, a stationary sealing O Ring 32 and a dynamically sealing O Ring 33.

Referring to FIG. 7 of the accompanying drawings, there is shown a close up view of FIG. 6 wherein is included an overhanging stationary component 30 which is disposed within stationary component 29 through the use of a press fit which is maintained by the interfering surfaces 34 and 35 situated accordingly on the primary stationary component 29 and the overhanging stationary component 30 and where the internal placement of the rotary component 28 is maintained through the contacting annular surface 36 on the primary stationary component 29 and a further contacting annular surface 37 on the rotary component 28.

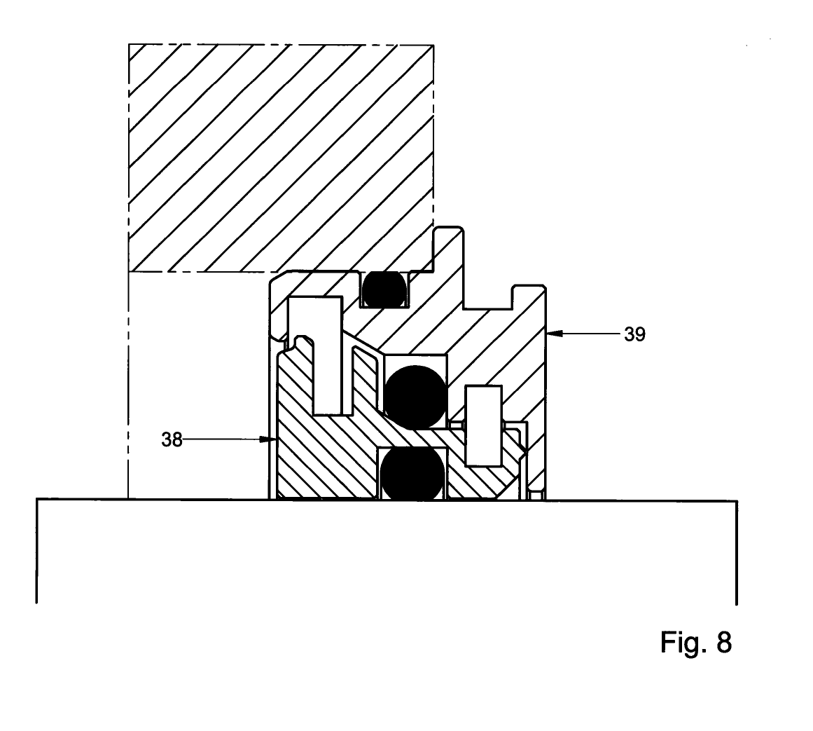

Referring to FIG. 8 of the accompanying drawings, there is shown a cross sectional view of an embodiment of a Bearing Isolator where is included a rotary component 38 and a stationary component 39 and where it is shown that the stationary component 39 significantly overhangs the rotary component 38 in such a way as the rotary component 38 is installed through the opposing side of the stationary component 39 thus providing a significant protection to the ingress of foreign bodies.

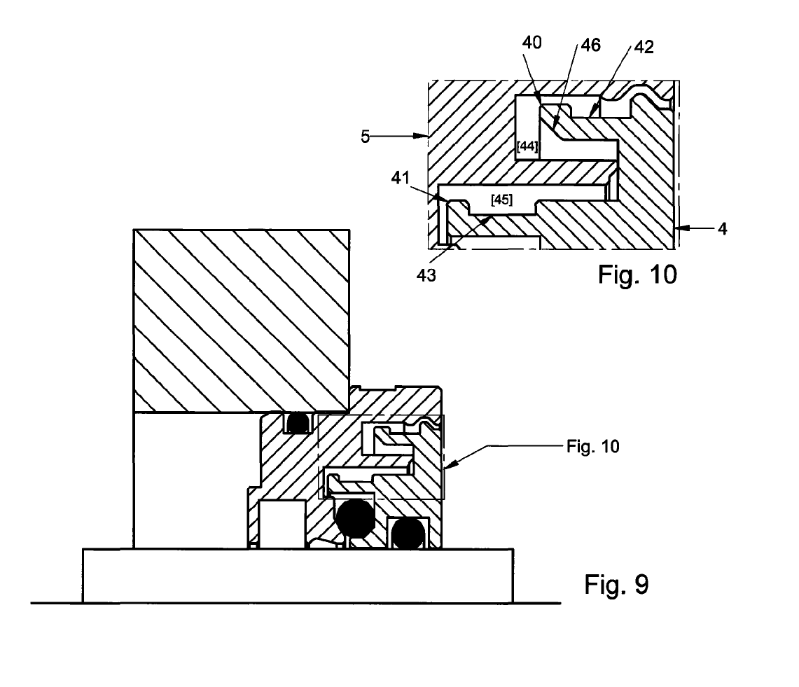

Referring to FIG. 9 of the accompanying drawings, there is shown a cross sectional view of a cross section of an embodiment of a Bearing Isolator in accordance with the present invention.

Referring to FIG. 10 of the accompanying drawings, there is shown a detail view of the interfacing profiles of the rotary component 4 and the stationary component 5 that form a tortuous path. Included in the tortuous path profile of the rotary component 4 are two protruding annular profiles 40 and 41 about which are accordingly situated two annular grooves 42 and 43 for preventing the further ingress of fluids and/or solids and where the protruding profiles 40 and 41 are in two spatial voids 44 and 45 which are intended to retain a greater volume of ingressed fluids and/or solids until they are removed through the drainage port not show in this drawing. Further included in the protruding annular profile 40 is an angled surface 46 which is to aid the flow of ingressed fluid and/or solids through the drainage port not shown in this drawing.

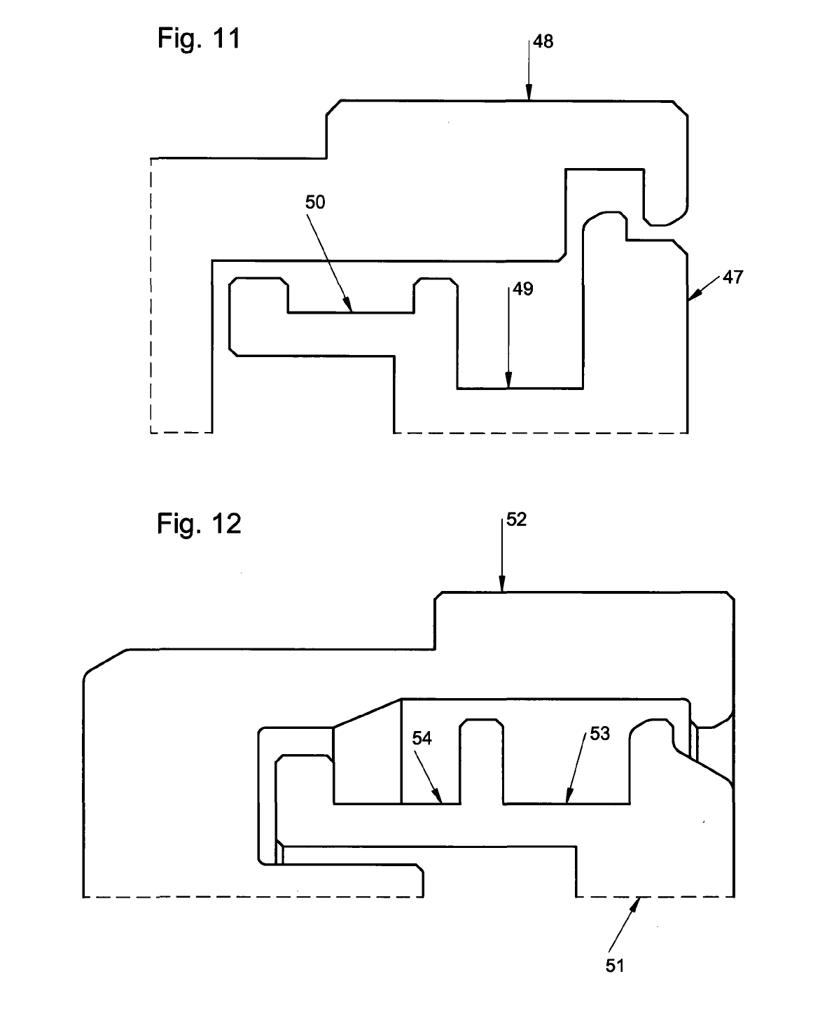

Referring to FIG. 11 of the accompanying drawings, there is shown a cross sectional view of an embodiment of the tortuous path profile which is comprised of a rotary component 47 and a stationary component 48 and wherein is included within the rotary component two annular grooves 49 and 50 for the prevention and retention of fluids and/or solids and where the primary annular groove 49 is significantly deeper so as to accommodate a greater ingress of fluids and/or solids.

Referring to FIG. 12 of the accompanying drawings, there is shown a cross sectional view of an embodiment of the tortuous path profile which is comprised of a rotary component 51 and a stationary component 52 and wherein is included within the rotary component two annular grooves 53 and 54 situated on the same horizontal plane and protruding axially perpendicular such that their accommodating volume is increase.

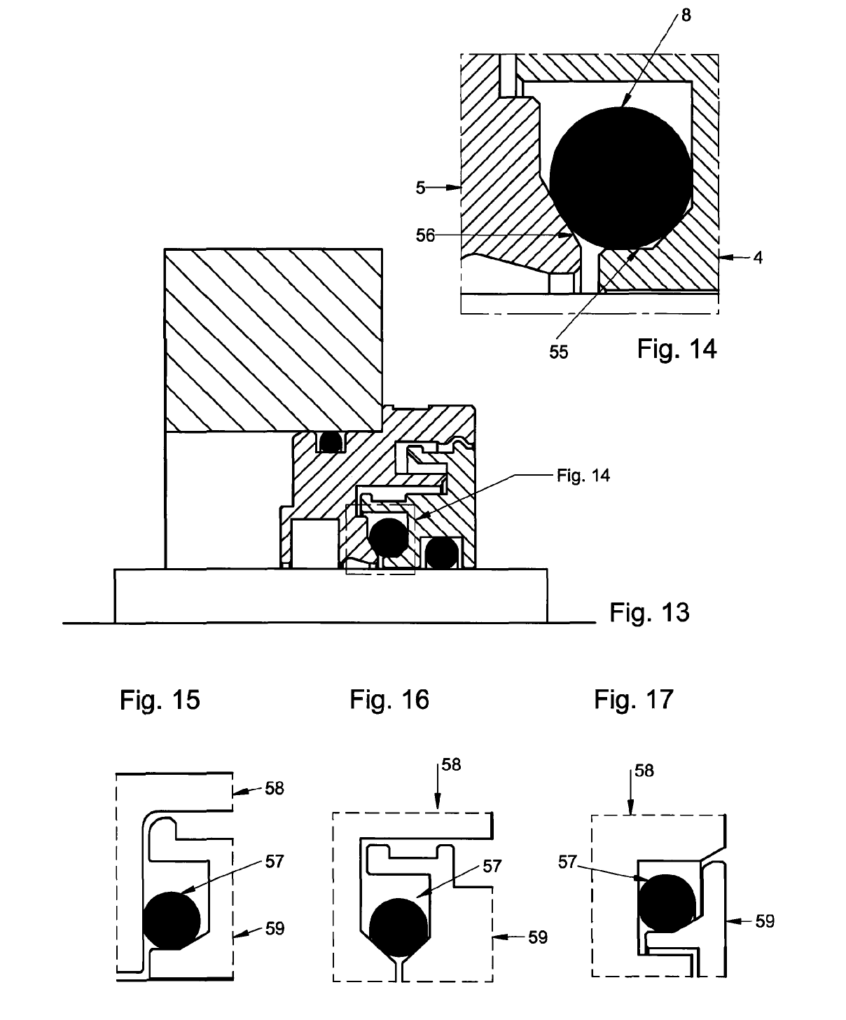

Referring to FIG. 13 of the accompanying drawings, there is shown a cross sectional view of a cross section of the preferred embodiment of a Bearing Isolator.

Referring to FIG. 14 of the accompanying drawings, there is shown a detail view of the dynamically sealing O Ring 8 situated between rotary component 4 and stationary component 5 wherein it is in contact with the rotary sealing surface 55 and the stationary sealing surface 56. During dynamic operation the O Ring 8 is energised by the rotary sealing surface 55 to the point that it lifts up thus relieving any built up pressure created through operation of the rotary equipment. The diameter of the rotary sealing surface 55 is such that when compared with the respective diameter of the O Ring 8 there is a predefined amount of stretch.

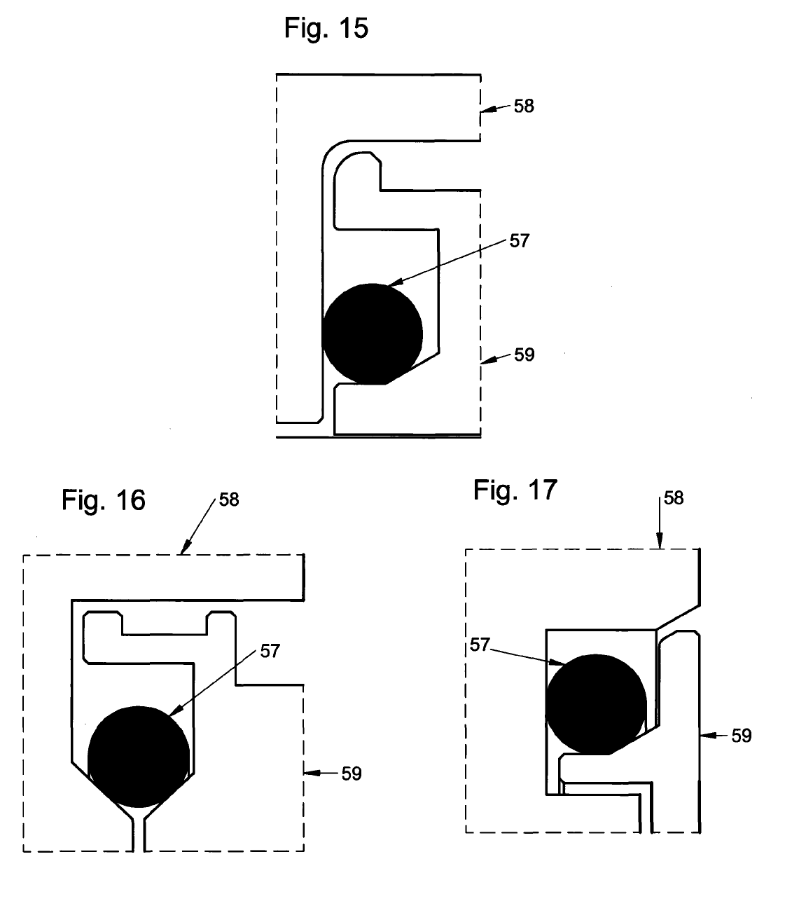

Referring to FIG. 15, FIG. 16 and FIG. 17 of the accompanying drawings, there is shown 3 embodiments of the dynamically sealing O Ring 57 situated accordingly between a rotary component 58 and a stationary component 59.

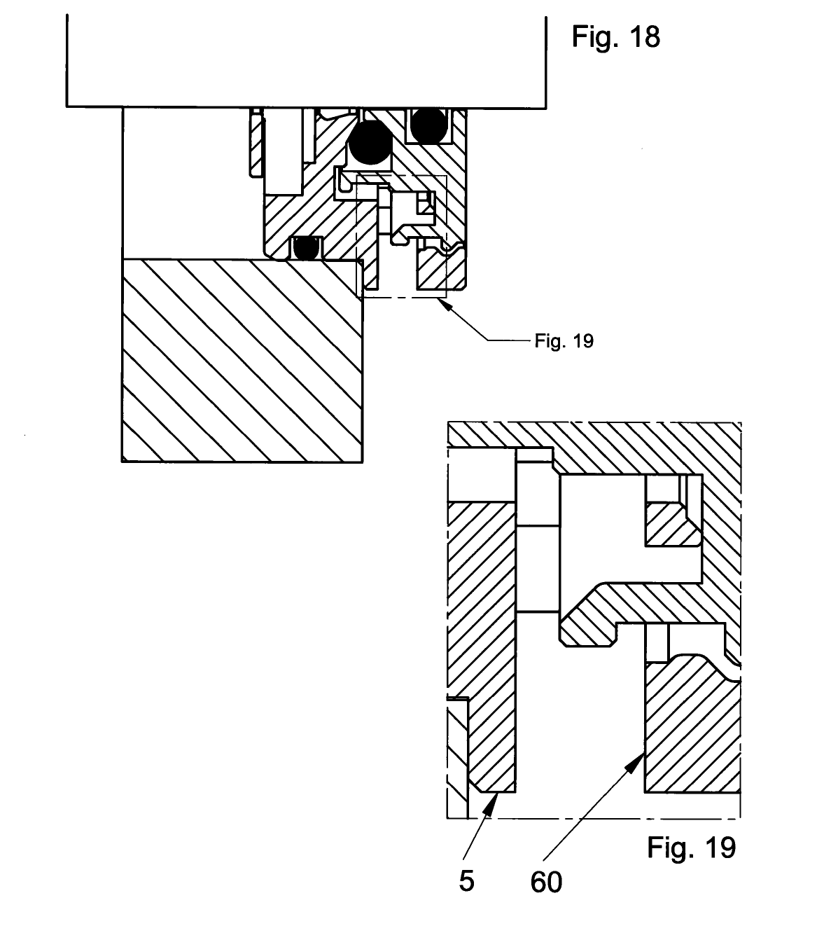

Referring to FIG. 18 of the accompanying drawings, there is shown a cross sectional view of a cross section of an embodiment of a Bearing Isolator in accordance with the present invention.

Referring to FIG. 19 of the accompanying drawings, there is shown a detail view of a drainage port 60 situated at the lowest gravitational point of the Bearing Isolator wherein the drainage port 60 is formed through the removal of material from the stationary component 5 such that fluids and/or solids may be drained from the spatial voids 44 and 45, see FIG. 10.

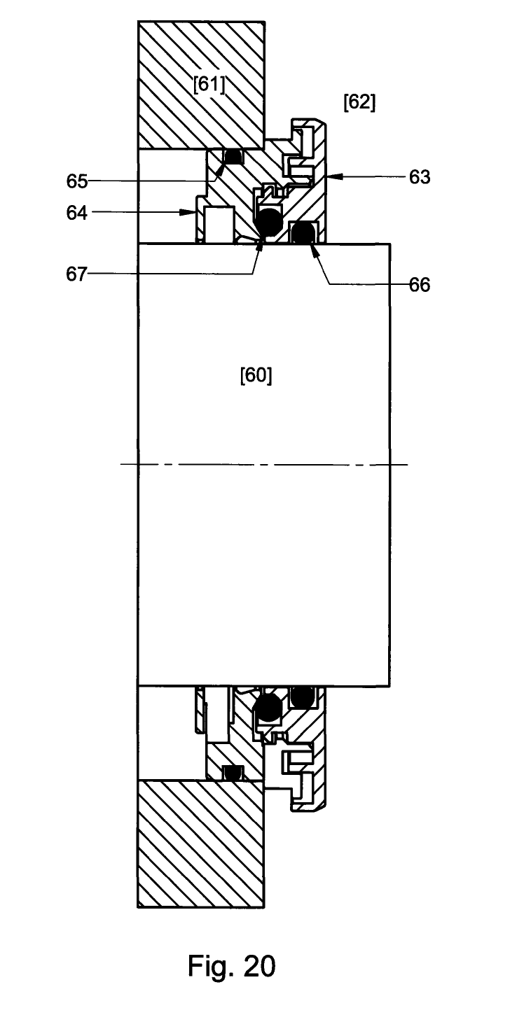

Referring to FIG. 20 of the accompanying drawings, there is shown a cross section view of an embodiment of a bearing isolator in accordance with the present invention. It can be seen in said cross section that there is included a shaft 60 and a bore 61 wherein is included an assembly 62 of an embodiment of the invention which includes a rotary 63 and a stationary 64 and bore sealing o ring 65, a shaft sealing o ring 66 and a dynamic sealing O ring 67.

The device may comprise a snap-fit to hold the static and rotational components in axial alignment. The ‘snap fit’ may comprise an arrangement wherein the static and rotational components are held axially relative to one another by a third component. Alternatively, the components may be held in axial alignment by a first part comprising a protrusion on one part and the second part comprising a groove, or recess, that receives the protrusion of the first part. The protrusion and groove cooperate to hold the two parts in constant axial alignment.

1-13. (canceled)

14. A bearing isolator for controlling fluid flow, comprising a stationary component fixed relative to a housing and a rotary component fixed relative to a shaft, said stationary component and said rotary component being held axially relative to each other, with an annular sealing member having a first position, in contact with both said static component and said rotary component, and a second position, in contact with either or both of said stationary component and said rotary component, said stationary component and said rotary component having a profile for creating a flow path between said stationary component and said rotary component, wherein the flow path includes at least one feature for slowing a flow of fluid therethrough, and further comprising means for holding said rotary component relative to said stationary component via a contacting annular surface so that minimum axial distances between said stationary component and said rotary component are substantially constant, said contacting annular surface being designed for wearing to a point wherein a microgap is formed between said stationary component and said rotary component.

15. The bearing isolator for controlling fluid flow according to claim 14, wherein the profile of said stationary component includes an annular recess and the profile of said rotary component includes an annular protrusion, wherein said annular protrusion is received within said annular recess of said stationary component for forming a part of the flow path.

16. The bearing isolator for controlling fluid flow according to claim 15, wherein said annular protrusion is substantially at an edge of said rotary component and forms lip for being received within a corresponding recessed edge of said stationary component, thereby creating an overhang.

17. The bearing isolator for controlling fluid flow according to claim 15, wherein an outmost part of said stationary component includes a lip and said rotary component includes a corresponding recess.

18. The bearing isolator for controlling fluid flow according to claim 14, wherein the profile of said rotary component includes an annular recess and the profile of said stationary component includes an annular protrusion, wherein said annular protrusion is received within said annular recess of said rotary component for forming a part of the flow path.

19. The bearing isolator for controlling fluid flow according to claim 18, wherein said annular protrusion is substantially at an edge of said stationary component and forms lip for being received within a corresponding recessed edge of said rotary component, thereby creating an overhang.

20. The bearing isolator for controlling fluid flow according to claim 18, wherein an outmost part of said stationary component includes a lip and said rotary component includes a corresponding recess.

21. The bearing isolator for controlling fluid flow according to claim 14, wherein the profile of an outermost part of said stationary component includes means for unitization between said stationary component and said rotary component.

22. The bearing isolator for controlling fluid flow according to claim 14, wherein a section of the profile of said rotary component forms a largest diameter, wherein diameters of sections of profile adjacent on said stationary component are lesser in diameter at their lowest point.

23. The bearing isolator for controlling fluid flow according to claim 22, wherein the sections of profiles adjacent on said stationary component are angled for creating a deflecting surface to a normal path of the fluid path.

24. The bearing isolator for controlling fluid flow according to claim 14, wherein the flow path is formed through at least one concentrically protruding profile.

25. The bearing isolator for controlling fluid flow according to claim 14, wherein the profile for creating the flow path between said stationary component and said rotary component includes at least one annular groove.

26. The bearing isolator for controlling fluid flow according to claim 14, wherein said stationary component has at its lowest gravitational point an internally protruding void, so that an ingress of fluids or solids are removable from an internal cavity of said bearing isolator.

27. The bearing isolator for controlling fluid flow according to claim 26, wherein the internally protruding void allows for release of ingressed fluids or solids from all internal cavities situated prior to said annual sealing member.

28. The bearing isolator for controlling fluid flow according to claim 14, wherein said annular sealing member is located on said rotary component so that said annular sealing member can be energized into a lifted state when said rotary component is rotating.

29. The bearing isolator for controlling fluid flow according to claim 14, wherein said annular sealing member is toroidally shaped.

30. The bearing isolator for controlling fluid flow according to claim 14, wherein said stationary component and said rotary component are axially held relative to one another via an additional component.
